(19) United States
(12) Patent Application Publication
(10) Pub. No.: US 2006/0069908 A1
(43) Pub. Date: Mar. 30, 2006

(54) Information processing apparatus and boot control method

(75) Inventors: Toru Hanada, Ome-shi (JP); Katsunori Horibe, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/082,036

(22) Filed: Mar. 17, 2005

(30) Foreign Application Priority Data
Sep. 27, 2004 (JP) JP 2004-280481

(51) Int. Cl. G06F 9/24

(52) U.S. Cl. 713/2

(57) ABSTRACT

When a computer system including a LAN device is to be booted, a LAN option ROM code of the LAN device and BIOS-ROM information are loaded in a RAM. Thus, boot is executed.

### CROSS-REFERENCE TO RELATED APPLICATIONS

This application is based upon and claims the benefit of priority from prior Japanese Patent Application No. 2004-280481, filed Sep. 27, 2004, the entire contents of which are incorporated herein by reference.

### BACKGROUND OF THE INVENTION

1. Field of the Invention

The present invention relates to an information processing apparatus and a boot control method, wherein the operation mode of a device is freely settable.

2. Description of the Related Art

In a conventional computer system with option boards, option ROM codes (operation information) for a personal computer (PC) are set on the option boards, which are connected to the PC via a bus interface such as an ISA or a PCI, as a boot code and an in-operation code that are dedicated to an associated device. There is no method for the BIOS of the PC to discriminate which kind of option board is connected. The BIOS executes, without fail, formatting of option ROM codes and a boot routine so as to be able to activate any kind of board. These methods and interfaces are standardized.

In the standardized procedures, an interface for switching the operation of the option ROM is not provided. In a case where the option ROM is equipped with two or more different functions, the following method is adopted in order to switch the function. That is, the option ROM code is individually provided with a user interface (UI), and the user executes selection at the time of boot (see, e.g. Jpn. Pat. Appln. KOKAI Publication No. 8-44571).

However, in the prior-art computer system having an option board, even when the setting of the option board is needless, a setting screen of the option board is displayed to the user each time the computer system is booted. This leads to an increase in boot time. Moreover, when the setting of the option board is to be changed, it is necessary to cause the setting screen to be displayed in association with each option board, and to change the setting. The same problem arises in the case of an on-board device, as well as the option board.

### BRIEF SUMMARY OF THE INVENTION

The object of the present invention is to provide an information processing apparatus and a boot control method, wherein a procedure for switching the operation mode of a device can be omitted when a computer system is booted.

An information processing apparatus according to claim 1 comprises: a device that has a plurality of operation modes and is operable in one operation mode of the plurality of operation modes; first memory means for storing operation information of a system and operation information relating to the operation mode of the device; rewritable second memory means in which the operation information relating to the operation mode of the device, which is stored in the first memory means, is written; selection means for selecting one of the plurality of operation modes of the device; nonvolatile third memory means for storing setting information based on the operation mode that is selected by the selection means; and setting means for setting the operation information that is stored in the second memory means, on the basis of the setting information that is stored in the third memory means.

A boot control method according to claim 2, for use in a system including a device that has a plurality of operation modes and is operable in one operation mode of the plurality of operation modes, comprises: a first storing step of storing, in first memory means, operation information of the system and operation information relating to the operation mode of the device; a second storing step of writing in rewritable second memory means the operation information relating to the operation mode of the device, which is stored in the first memory means; a selection step of selecting one of the plurality of operation modes of the device; a third storing step of storing, in nonvolatile third memory means, setting information based on the operation mode that is selected by the selection step; and a setting step of setting the operation information that is stored in the second memory means, on the basis of the setting information that is stored in the third memory means.

The present invention can provide an information processing apparatus and a boot control method, which can omit a procedure for switching the operation of a device at a time of booting a computer system.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view that shows an information processing apparatus according to an embodiment of the present invention;

FIG. 2 shows the configuration of the information processing apparatus according to the embodiment of the invention;

FIG. 3 shows a BIOS setup screen according to the embodiment of the invention;

FIG. 4 is a flow chart that illustrates a setting operation when the BIOS setup screen according to the embodiment of the invention is caused to appear;

FIG. 5 illustrates a process that is executed from the ROM side to the RAM side when the BIOS setup screen according to the embodiment of the invention is displayed;

FIG. 6 is a flow chart that illustrates a process for initializing an option ROM code when the information processing apparatus according to the embodiment of the invention is booted; and

FIG. 7 is a flow chart that illustrates an initialization process for an option ROM code that is copied to the RAM, according to the embodiment of the invention.

### DETAILED DESCRIPTION OF THE INVENTION

An embodiment of the present invention will now be described with reference to the accompanying drawings.

In the technique of this embodiment, an option ROM of a device is integrally provided in a ROM that stores the BIOS of a computer system. When there is no need to switch the operation mode of the device, an operation mode switching screen is not displayed at the time of boot. When there is a need to switch the operation mode of the device, variation settings of the device can be executed on a BIOS setting screen. In the embodiment below, the computer system is realized as a notebook computer (information processing apparatus). The invention, however, is also applicable to, e.g. a desktop computer.

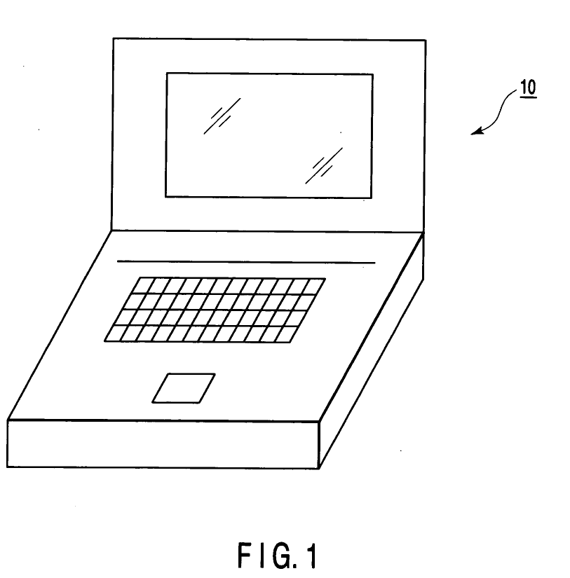

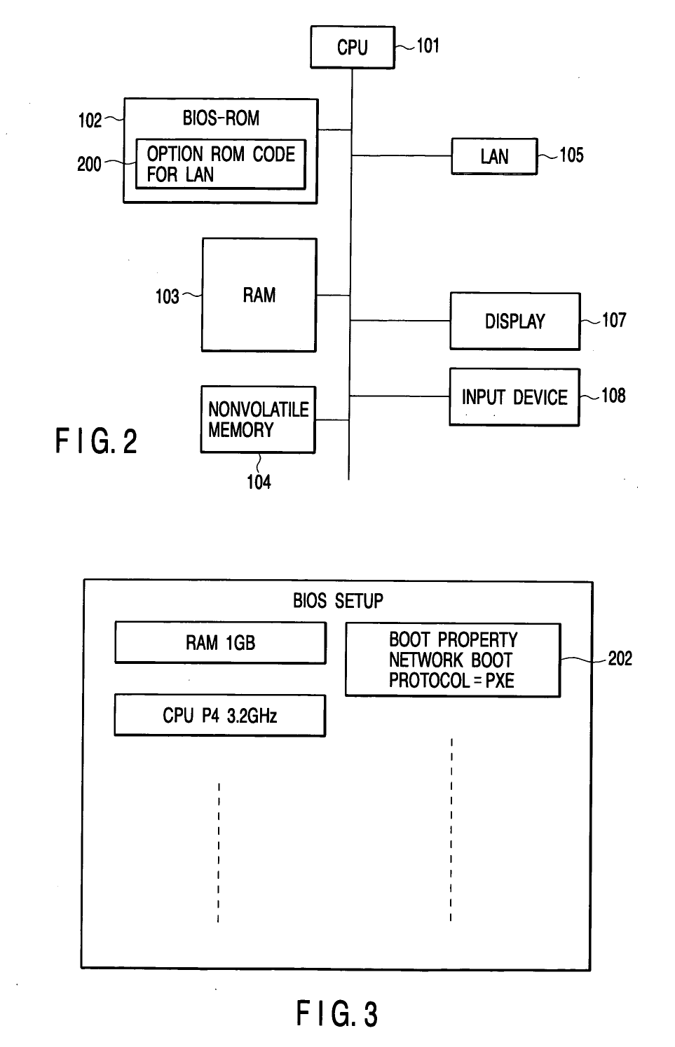

FIG. 1 shows the information processing apparatus according to the embodiment of the present invention. FIG. 2 shows the configuration of the information processing apparatus according to the embodiment. A notebook computer 10 (hereinafter referred to as “computer”) that is the information processing apparatus has a system configuration as shown in, e.g. FIG. 2. In the embodiment, a LAN board is used as a device.

The computer 10 comprises a CPU 101 that executes an overall control of the computer system; a BIOS-ROM (first memory means) 102 that stores operation information (basic input/output system (BIOS)) of the entire system; a LAN device 105 that is connectable to a network; a RAM (second memory means) 103 in which data is loaded from the ROM 102; a nonvolatile memory (a CMOS memory that is backed up by a battery) (third memory means) 104 that stores various setting information of the BIOS; a display device 107, such as a display, that displays various information such as BIOS settings to the user; and an input device 108, such as a keyboard or a mouse, that is used to input data when the user executes BIOS setting.

The BIOS-ROM 102 includes a memory area that prestores an option ROM code (operation information) 200 of the LAN device 105. When the user intends to change settings of various devices or the system, the user operates the input device 108 of the computer 10 at the time of booting the computer 10. Thereby, a BIOS setup screen can be displayed. If the user does not voluntarily display the BIOS setup screen, the BIOS setup screen is not displayed and the installed OS (operating system) is normally activated.

FIG. 3 shows the BIOS setup screen according to the embodiment of the present invention.

The BIOS setup screen has a structure as shown in, e.g. FIG. 3. The BIOS setup screen includes an operation mode switching area 202 for the LAN option ROM code 200 of the LAN device, in addition to areas for displaying set values of various devices of the computer system. For example, the user uses the input device 108 to voluntarily switch the LAN option ROM code 200 from PXE (first operation mode), which is currently set, to RPL (second operation mode). This switching operation is executed by a switching method using cursor movement, an “Enter” key and a space key on the keyboard, for instance. Alternatively, a mouse or voice may be used.

The BIOS setup screen may be displayed only when the LAN option ROM code 200 of the device is to be switched. Switching selection of the LAN option ROM code 200 is not prompted each time the computer system is started. In addition, no wait time occurs.

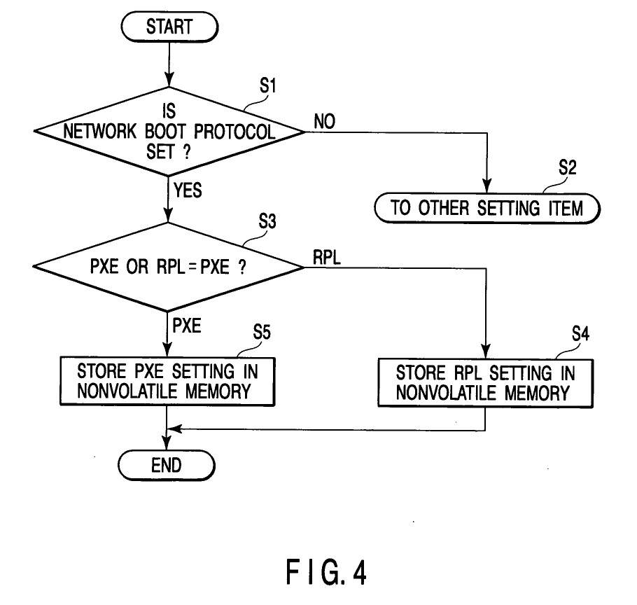

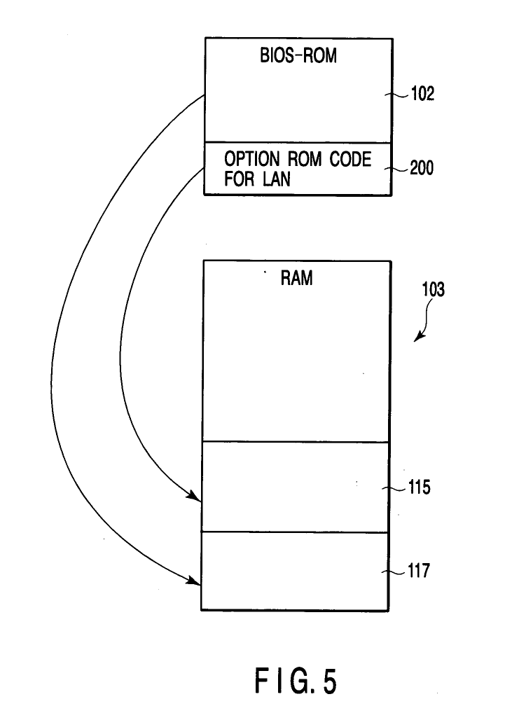

A setting operation when the BIOS setup screen is displayed is described. FIG. 4 is a flow chart that illustrates a setting operation when the BIOS setup screen according to the embodiment of the invention is caused to appear. FIG. 5 illustrates a process that is executed from the ROM side to the RAM side when the BIOS setup screen according to the embodiment of the invention is displayed.

When the BIOS setup screen is displayed, the data of the BIOS-ROM 102 is loaded in a predetermined memory area 117 of the rewritable RAM 103, as shown in FIG. 5. In addition, the data of the LAN option ROM code 200, which is stored in the BIOS-ROM 102, is loaded in a predetermined memory area 115 of the RAM 103.

In the above state, the CPU 101 determines whether a setting of Network Boot Protocol is selected on the BIOS setup screen (step S1 in FIG. 4). If it is determined in step S that the setting of Network Boot Protocol is not selected, a setting of another item is determined in step S2 and the selection relating to this item is executed. On the other hand, if it is determined in step S1 that the setting of Network Boot Protocol is selected in step S1, the CPU 101 determines whether the selected setting (operation mode) is PXE or RPL (step S3). If the CPU 101 determines in step S3 that the selected operation mode is PXE, the operation mode of the LAN 105 is set in the nonvolatile memory 104 as the PXE mode (step S5). On the other hand, if the CPU 101 determines in step S3 that the selected setting (operation mode) is RPL, the operation mode of the LAN 105 is set in the nonvolatile memory 104 as the RPL mode (step S4).

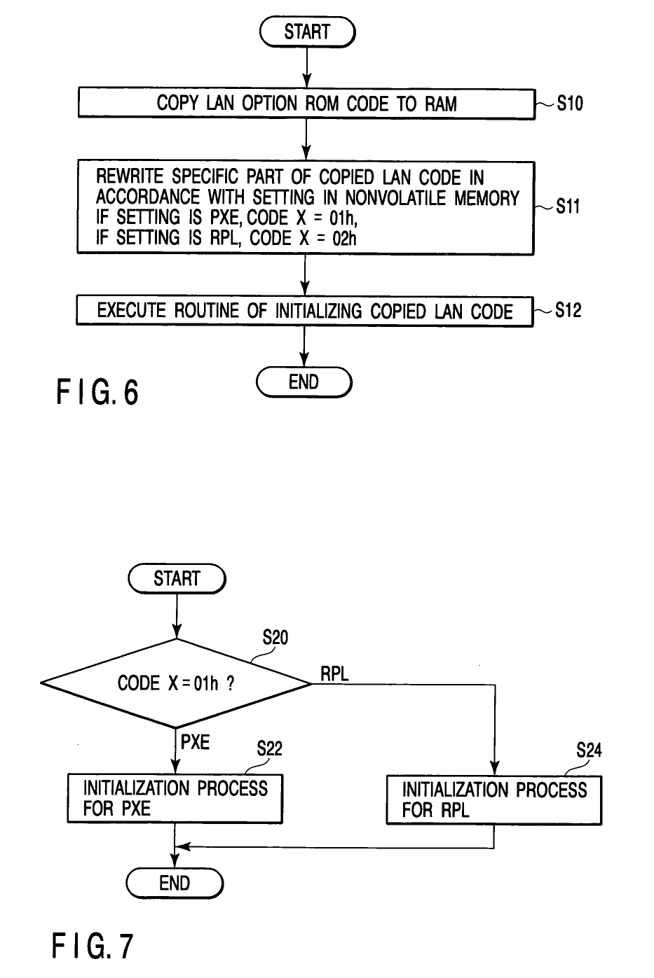

FIG. 6 is a flow chart that illustrates a process for initializing an option ROM code when the computer 10 is booted.

In step S10, the CPU 101 loads the option ROM code 200 into the RAM 103. In step S11, the CPU 101 changes the code X (setting value), which is a part of the option ROM code 200 loaded in the RAM 103, in accordance with the protocol setting value (PXE setting or RPL setting) for the user's network boot, which is stored in the nonvolatile memory 104. In the changing process, in the case of the PXE setting, the code X is changed to 01h. In the case of the RPL setting, the code X is changed to 02h. In step S12, the CPU 101 executes an initialization routine for the option code.

FIG. 7 is a flow chart that illustrates an initialization process for the option ROM code 200 that is loaded in the RAM 103.

The CPU 101 executes one of two different initialization processes in accordance with the information written in the code X. In step S20, the CPU 101 determines whether the code X is 01h or not. If the code X is 01h (PXE mode) in step S20, the CPU 101 executes an initialization process, with the PXE mode being set as the operation mode of the LAN 105 (step S22). On the other hand, if it is determined in step S20 that the code X is not 01h (PXE mode), that is, the code X is 02h (RPL mode), the CPU 101 executes an initialization process, with the RPL mode being set as the operation mode of the LAN 105 (step S24).

In the prior art, the setting screen, which is a user interface (UI) for various settings of the BIOS, is independent from the setting UI that is provided in the option ROM. When the user executes respective settings, the respective user interfaces need to be activated individually and the settings need to be executed individually. However, according to the embodiment of the invention, the setting of the option ROM is integrally provided in the UI for various settings of the BIOS. The user can execute the setting of the option ROM in the BIOS setting at a time through the integral setting UI. In addition, the operation of the option ROM code can be switched in accordance with the integral various settings of the BIOS.

In the present embodiment, the LAN device is used as the device. However, the device may be any device that includes an option ROM code, such as a SCSI device or a RAID device. The device may be configured to be detachably connected to the system board, or to be mounted on the system board.

The present invention is not limited to the above-described embodiment. At the stage of practicing the invention, various modifications and alterations may be made without departing from the spirit of the invention. Structural elements disclosed in the embodiment may properly be combined, and various inventions can be made. For example, some structural elements may be omitted from the embodiment. Moreover, structural elements in different embodiments may properly be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a device that has a plurality of operation modes and is operable in one operation mode of said plurality of operation modes;
first memory means for storing operation information of a system and operation information relating to the operation mode of the device;
rewritable second memory means in which the operation information relating to the operation mode of the device, which is stored in the first memory means, is written;
selection means for selecting one of said plurality of operation modes of the device;
nonvolatile third memory means for storing setting information based on the operation mode that is selected by the selection means; and
setting means for setting the operation information that is stored in the second memory means, on the basis of the setting information that is stored in the third memory means.

2. A boot control method for use in a system including a device that has a plurality of operation modes and is operable in one operation mode of said plurality of operation modes, the method comprising:
a first storing step of storing, in first memory means, operation information of the system and operation information relating to the operation mode of the device;
a second storing step of writing in rewritable second memory means the operation information relating to the operation mode of the device, which is stored in the first memory means;
a selection step of selecting one of said plurality of operation modes of the device;
a third storing step of storing, in nonvolatile third memory means, setting information based on the operation mode that is selected by the selection step; and
a setting step of setting the operation information that is stored in the second memory means, on the basis of the setting information that is stored in the third memory means.
